(19) United States
(12) Patent Application Publication
(10) Pub. No.: US 2017/0270380 A1
(43) Pub. Date: Sep. 21, 2017

(54) FINGERPRINT ENROLLMENT IN SMART DEVICE

(71) Applicant: Fingerprint Cards AB, Göteborg (SE)

(72) Inventors: Anders Khullar, BJÄRRED (SE); Olis Olofsson, MALMÖ (SE)

(73) Assignee: Fingerprint Cards AB, Göteborg (SE)

(21) Appl. No.: 15/457,426

(22) Filed: Mar. 13, 2017

(30) Foreign Application Priority Data
Mar. 16, 2016 (SE) 16503518

(51) Int. Cl. G06K 9/00; H04W 4/00; H04M 1/02; H04L 29/12

(52) U.S. Cl. CPC G06K 9/00926; H04L 61/203; H04W 4/008; H04M 1/0202; G06K 9/00087; H04W 84/12

(57) ABSTRACT

A smart device is used for controlling enrollment in a fingerprint sensing system. The smart device comprises a fingerprint sensor and a number of actions are performed in the smart device that commences with establishing a connection with a wireless communication device. The wireless communication device comprises a MMI. A user authentication and authorization, AA, process is performed. Depending on an outcome of the AA process, a fingerprint enrollment process is performed that comprises registering data representing a fingerprint of the user in the smart device and that comprises communication with the wireless communication device via the connection.

### TECHNICAL FIELD

Embodiments herein relate to methods and arrangements relating to enrollment of fingerprints in a fingerprint sensing system and specifically to enrollment associated with a smart device.

### BACKGROUND

In the field of biometric sensing, the use of fingerprints has evolved to be one of the most widely used technologies. This fact can be illustrated and exemplified by considering the field of mobile communication technology, e.g. the use of intelligent mobile devices such as smartphones. In this field there is an increased demand for providing increased security for accessing the devices themselves and also for providing secure access to remote services such as banking services that are available via data communication networks.

Another field where fingerprint sensing has become very useful is that of access systems (e.g. physical access systems) that require users to present a smart device in the form of a so-called smart device to a smart device and perform some kind of authentication procedure, e.g. entering a password via a keypad on the smart device.

However, it is foreseen that authentication and authorization will become more common in other contexts than physical access systems. In fact, any apparatus having at least some electrical/electronic circuitry may be equipped with circuitry that can be configured to control access to the apparatus. Such apparatuses may of course also be equipped with a fingerprint sensor and processing circuitry and thereby provide the apparatus with access control in more or less the same manner as traditional physical access systems. Examples of such apparatuses may include any typical household device such as vacuum cleaners, ovens, stoves, toasters, blenders, dish washers, washing machines etc. Many of such devices may be dangerous if not handled carefully and an easy to use access control may be very relevant.

In order to enable such secure access by way of fingerprint sensing, a user has to take part in a so-called enrollment procedure where information directly connected to a user's fingerprint is registered for later use in a verification procedure when actual access is to be determined. During such an enrollment procedure the user is guided, for example prompted to apply a finger to a fingerprint sensor several times until a complete fingerprint or at least a large part of a fingerprint has been recorded. The procedure of enrolling a fingerprint is typically performed by use of a fingerprint sensor arranged in a terminal or docking station at a location such as a bank office or by means of a fingerprint sensor arranged in a wireless communication device such as a smartphone.

However, in order to be of practical use in an enrollment procedure, a fingerprint sensor in a smart device requires some kind of man-machine interface (MMI) in order to communicate with the user for guidance and instructions. In a smart device, such as the devices mentioned above, there is no way to communicate unless the smart device is connected to a docking station with a display.

Moreover, there are also concerns regarding security when considering using a smart device in a fingerprint sensing context. A smart device is typically obtained by a user simply by buying it in a shop or receiving it by regular mail or courier services. The smart device is “blank” when delivered, i.e., the device does not contain the specific user's fingerprint, which means that there is need for ensuring that only the specific user is able to enroll a fingerprint in the smart device. This security issue is typically handled by way of providing the user with a separate message (typically by means of a regular letter via regular mail) that provides an unlocking code such as a password, personal identification number (PIN) etc., for the smart device. This enables the specific user to enroll a fingerprint for the very first time by using the provided unlocking code. Today, there is no way to enter such an unlocking code without a secure docking station. This can be very time consuming if it requires a visit at a specific registration location such as a bank office etc.

An example of a prior art arrangement is described in US patent application publications 2008/0028230. In this publication, a biometric proximity card co-operates with an access system. The biometric proximity card of US 2008/0028230 can be used together with a smartcard reader during an enrollment process.

### SUMMARY

In order to mitigate at least some of the drawbacks as discussed above, there is provided in a first aspect of embodiments herein a method performed by a smart device for controlling enrollment in a fingerprint sensing system. The smart device comprises a fingerprint sensor and the method comprises a number of actions that commences with establishing a connection with a wireless communication device. The wireless communication device comprises a MMI. A user authentication and authorization, AA, process is then performed. Depending on an outcome of the AA process, a fingerprint enrollment process is performed that comprises registering data representing a fingerprint of the user in the smart device and that comprises communication with the wireless communication device via the connection.

In some embodiments, the AA process comprises communication with the wireless communication device via the connection.

Embodiments include those wherein the AA process comprises receiving user input from the MMI via the connection from the wireless communication device and some embodiments comprise receiving data representing AA process outcome via the connection from the wireless communication device.

In some embodiments, the AA process comprises detecting a user triggered signal in the smart device.

With regard to the fingerprint enrollment process that is performed depending on the outcome of the AA process, there are various embodiments. For example, the enrollment process may comprise detecting fingerprint images in the fingerprint sensor (i.e. the sensor in the smart device) or receiving fingerprint images from the wireless communication device (e.g. from a sensor in the wireless communication device). During such detection or reception of fingerprint images, guidance information is transmitted to the MMI via the connection from the wireless communication device. Alternatively, in some embodiments the data representing a fingerprint may be received via the connection from the wireless communication device. That is, in such embodiments it is assumed that fingerprint images have already been processed, by the wireless communication device, into the data that represents a fingerprint.

The performing of the AA process may be iterated and check may be made whether or not the AA process is performed a specific number of times. If this specific number of times is above a first or a second threshold number, the method may simply be ended or the smart device may also be disabled prior to the method being ended.

Embodiments include those where the connection with the wireless communication device comprises any of a near field communication, NFC, Bluetooth®, radio frequency identification, RFID, and WiFi connection.

In other words, these summarized embodiments provide a use of a wireless communication device, such as a smartphone, for controlling fingerprint enrollment using a smart device. The embodiments provide a secure context such that the smart device may be sent by regular mail to a user and the smart device contains no information about any fingerprints, i.e. no fingerprint is enrolled in the smart device when received by the user. An authentication and authorization code such as a password or personal identification number (PIN) may be sent separately through regular or electronic mail to the user for use when performing an enrollment process with the smart device. The wireless communication device may have more or less simple software installed that can communicate with the smart device, e.g. through near field communication (NFC) circuitry. When a connection is present between the smart device and the wireless communication device, the software in the wireless communication device may co-operate with software in the smart device and realize the guiding of the user in the enrollment process and in some embodiments also realize the AA process via the connection.

In embodiments where a user is already authenticated and authorized, having operated appropriate software, e.g., in the wireless communication device, then the smart device may continue directly with an enrollment process or make use of data representing a fingerprint (e.g. a fingerprint template) received from the smartphone in the AA procedure.

Further advantages of the above embodiments include the possibility to block large number of failed attempts and, if several attempts are made without the user being authenticated and authorized, the smart device may even be disabled for further usage.

In a second aspect there is provided a smart device, for controlling enrollment in a fingerprint sensing system. The smart device comprises a fingerprint sensor, a processor and a memory. The memory contains instructions executable by the processor whereby the smart device is operative to:
establish a connection with a wireless communication device, the wireless communication device comprising a man-machine interface (MMI),
perform a user authentication and authorization (AA) process, and
depending on an outcome of the AA process, perform a fingerprint enrollment process that comprises registering data representing a fingerprint of the user in the smart device and that comprises communication with the wireless communication device via the connection.

Embodiments of the apparatus include those that correspond to the method embodiments summarized above.

In various embodiments, the smart device may be a household apparatus.

In a further aspect there is provided a computer program comprising instructions which, when executed on at least one processor in a smart device, cause the smart device to carry out the method according to the first aspect and, in yet another aspect, a carrier comprising the computer program.

Effects and advantages of these further aspects correspond to those summarized above in connection with the first aspect.

### BRIEF DESCRIPTION OF THE DRAWINGS

FIG. 1a schematically illustrates a fingerprint sensing system;

FIG. 1b schematically illustrates a smart device in the form of a smart card;

FIGS. 1c-e schematically illustrates a smart device in the form of a respective household device; and

FIGS. 2a and 2b are flowcharts of embodiments of a method in a smart device.

### DETAILED DESCRIPTION

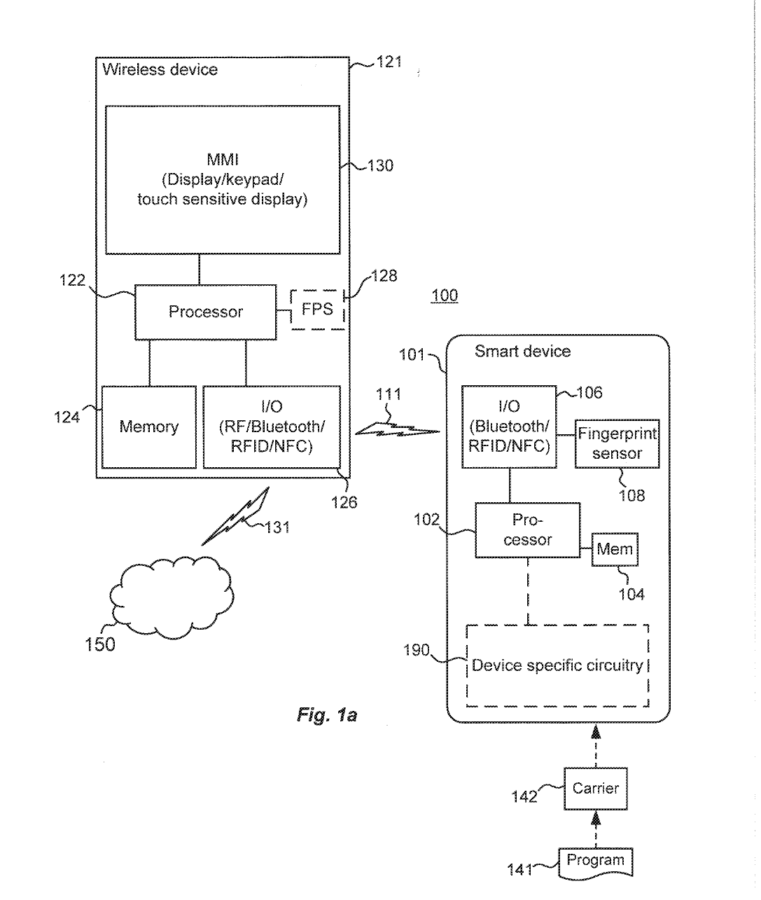

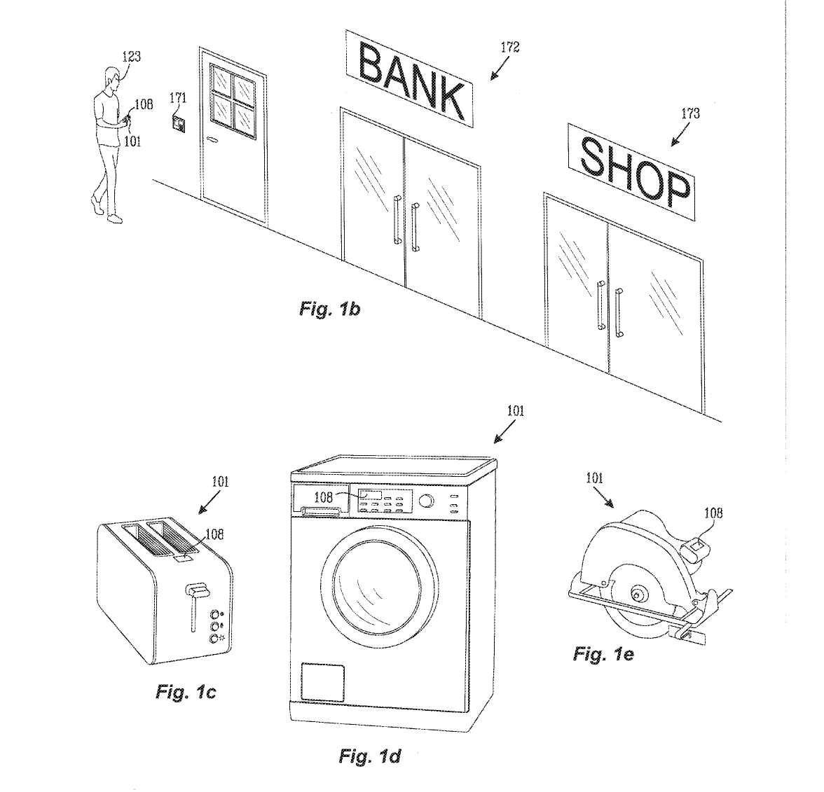

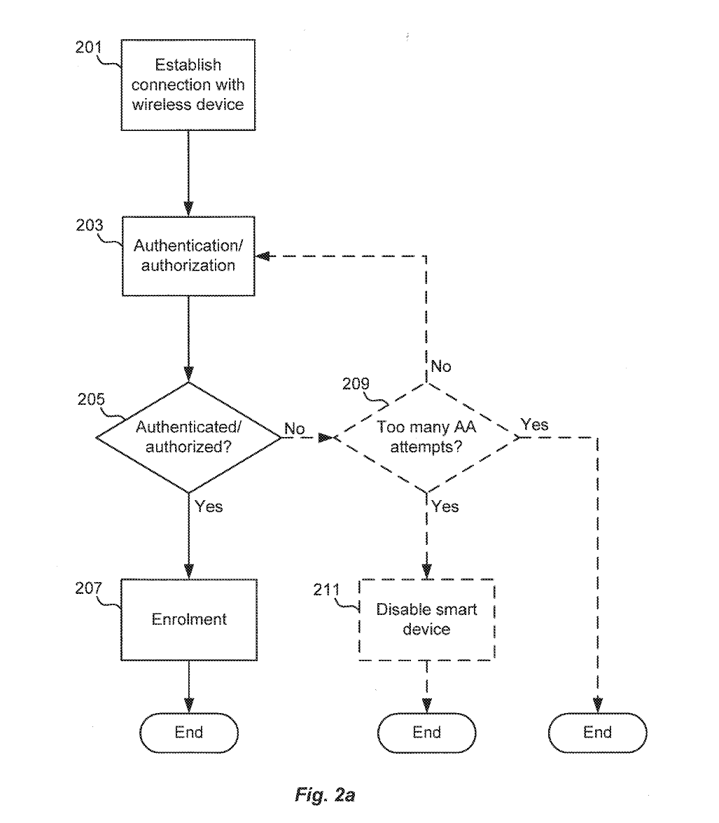

FIG. 1a illustrates schematically in the form of function blocks a fingerprint sensing system 100. The system 100 comprises a smart device 101 and a wireless communication device 121, which is available to a user as will be described.

The smart device 101 comprises a processor 102, a memory 104 and input/output circuitry 106, which may realize a connection 111 with the wireless communication device 121 and it may be of any appropriate type such as near field communication, NFC, circuitry, Bluetooth® circuitry, radio frequency identification (RFID) circuitry, WiFi circuitry etc. and a fingerprint sensor 108. Needless to say, other configurations of the circuitry of the smart device 101 are also possible, including architectures having two or more processors etc.

The fingerprint sensor 108 may be of any suitable type, such as optical, capacitive, ultrasonic etc., as the skilled person will realize. The fingerprint sensor 108 may be of a one-dimensional type or a two-dimensional type. A two-dimensional sensor comprises a square or rectangular shaped matrix of pixels, for example a capacitive sensor having a size of 208×80 pixels, each pixel having a resolution of 256 grey scales. The fingerprint sensor 108 typically comprises a readout circuit (not shown in FIG. 1) allowing image data, i.e. fingerprint data, to be read out to the processor 102 at various speeds. The processor 102 controls, by means of software instructions, the smart device 101 to operate as will be exemplified below and operate to control the smart device 101 in the system 100, e.g. in an access control and/or a payment scenario in case the smart card is a smartcard such as an access card and/or a bank card and/or a credit card, via the circuitry 106 in a manner that is known to the skilled person and that is outside the scope of the present disclosure. The software instructions may be comprised in a computer program 141 and the computer program 141 may be comprised in a carrier 142 that may be of any appropriate form including an electronic signal, an optical signal, a radio signal and a computer readable storage medium.

The wireless communication device 121 may be in the form of a mobile phone, a smartphone, a tablet, a personal computer, a laptop computer or any similar type of device. The wireless communication device 121 comprises a processor 122, a memory 124 and input/output circuitry 126. The input/output circuitry 126 may comprise circuits configured for near field communication, NFC, Bluetooth® circuitry, RFID circuitry, WiFi circuitry and any appropriate radio circuitry configured to operate in a wireless communication system 150 via an air interface 131 according to, e.g., a cellular communication system standard. The wireless communication device 121 also comprises a MMI 130, which may be realized by means of a touch sensitive display. As will be described in detail below, the MMI 130 is configured to operate in conjunction with the smart device 101 in authentication and authorization (AA) processes as well as acting as a guidance information provider by providing graphical output for the user 123 during operation of the smart device 101. The processor 122 is configured to control the wireless communication device 121 to operate in the mobile communication system via the radio circuitry 126 in a manner that is outside the scope of the present disclosure.

The wireless communication device 121 may optionally also comprise a fingerprint sensor 128, which may be similar to the fingerprint sensor 108 in the smart device 101.

FIG. 1b illustrates an embodiment where the smart device 101 is in the form of a smartcard 101 for use by a user 123 in connection with, e.g., a physical access control arrangement 171, a bank 172 (e.g. a banking machine) and a shop 173 (e.g. a point of sale arrangement).

FIG. 1c illustrates an embodiment where the smart device 101 is in the form of a household item, specifically a toaster.

FIG. 1d illustrates an embodiment where the smart device 101 is in the form of a household item, specifically a washing machine.

FIG. 1e illustrates an embodiment where the smart device 101 is in the form of a household item, specifically a buzz-saw.

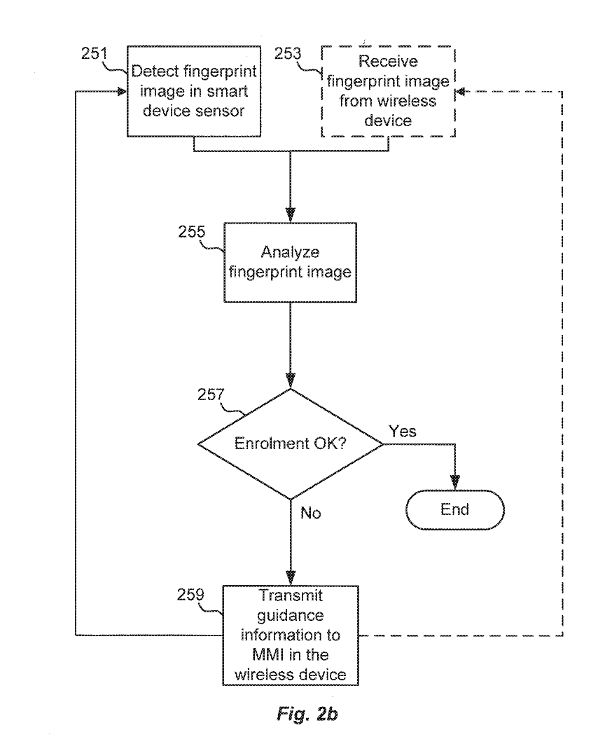

Turning now to FIGS. 2a and 2b and with continued reference to FIG. 1, a method performed by a smart device, e.g. the smart device 101 in FIG. 1, for controlling enrollment in a fingerprint sensing system 100 will be described in some detail. The method comprises a number of actions that will be described below. The actions of the method in FIGS. 2a and 2b may be realized by means of software instructions being executed in a processor, e.g. the processors 102, which interacts with a fingerprint sensor such as the sensor 108 and controls communication with a wireless communication device such as the wireless communication device 121 in FIG. 1. Memory such as the memory 104 is utilized during the execution of the method.

Action 201

A connection 111 is established with a wireless communication device that comprises a MMI. As described above, such a connection may be realized via the input/output functions 106, 126 in the smart device 101 and the wireless communication device 121, respectively. For example, the connection 111 may be an NFC, Bluetooth®, RFID, WiFi etc. connection. The connection may also, in various embodiments, involve initial connection via, e.g., NFC followed by continued connection via, e.g., Bluetooth or WiFi.

Action 203

A user authentication and authorization (AA) process is then performed.

The AA process may comprise communication with the wireless communication device via the connection that was established in action 201. For example, in some embodiments, the AA process may comprise receiving user input from the MMI in the wireless communication device 121 via the connection 111. Such user input via the MMI 130 may comprise characters of a password that is analysed and checked whether or not it is correct.

In some other embodiments, the AA process may comprise receiving data representing AA process outcome from the wireless communication device 121 via the connection 111. In such embodiments, the wireless communication device 121 has already performed an AA process associated with the user 123 wherein the AA process has knowledge of the fact that the smart device is associated or tied to the user 123. Such a process in the wireless communication device 121 may have utilized the fingerprint sensor 128, as the skilled person will realize. Having performed the AA process, the wireless communication device 121 provides the data that informs the smart device 101 of an outcome of the AA process that can be used in the AA process in the smart device 101.

Other embodiments of the AA process may comprise a detection of a user triggered signal in the smart device 101. That is, a very simple AA process may be performed by the user while, e.g., initiating use of the smart device 101. For example, the user pushing a switch or performing any other simple operation on the smart device 101 may generate a triggering signal that is considered as a positive outcome of the AA process. In embodiments where the smart device 101 is a household apparatus such as a washing machine, which typically comprises a control panel, any switch on such a control panel may be configured to provide such a triggering signal and thereby provide the outcome of the AA process.

Action 205

A decision is taken regarding an outcome of the AA process that was performed in action 203 such that a fingerprint enrollment process is performed in dependence of the outcome. For example, a positive outcome may entail that the user is authenticated and authorized and as a consequence the decision in action 205 is to perform action 207.

Action 207

Performance of the fingerprint enrollment process comprises registering data representing a fingerprint of the user 123 in the smart device 101. The fingerprint enrollment process also comprises communication with the wireless communication device 121 via the connection 111. It is to be understood that the concept of “data representing a fingerprint” may represent a more or less complete fingerprint and also, which is more typical in present day applications, a fingerprint template that represents or “encodes” a fingerprint in terms of fingerprint features.

For example, in some embodiments as illustrated in FIG. 2b, the fingerprint enrollment process may comprise detecting 251 fingerprint images in the fingerprint sensor 108, or receiving 253 fingerprint images from the wireless communication device 121, and transmitting 259 guidance information to the MMI 130 in the wireless communication device 121 via the connection 111 from the wireless communication device 121. In such embodiments, the fingerprint images that are detected by the sensor 108, or received from the wireless communication device 121, in the smart device are analysed 255 and, as the skilled person will realize, such analysis produces results that may correspond to various measures of how complete the images are in terms of reproducing a fingerprint that is useful for registering and subsequent use in verification procedures. As illustrated by a checking/decision action 257 decides whether or not the enrollment is satisfactory. Several fingerprint images are typically needed in order to complete a fingerprint and the user will need guidance, for example in the form of feedback, such that the user can place a finger on the sensor 108 (or sensor 128 in embodiments where the sensor 128 in the wireless communication device 121 is utilized) in a way that the fingerprint can be completed with as few images as possible. Such guidance may be in the form of suitably encoded instructions that can be represented by the MMI 130 in the wireless communication device 121, e.g. in the form of graphical symbols etc. as the skilled person will realize.

In some other embodiments, the fingerprint enrollment process may comprise receiving the data representing a fingerprint via the connection from the wireless communication device. That is, in such embodiments the data representing a fingerprint may be in the form of a fingerprint template that has been created as a result of a sequence of fingerprint images being detected by the fingerprint sensor 128 in the wireless communication device 121 and analysed in the wireless communication device 121. The data representing a fingerprint received from the wireless communication device 121 is then simply registered in the smart device 101 and thereby completing the enrollment process.

As FIG. 2a illustrates, the method may also comprise a decision action 209 and an action 211 that is performed as a consequence of the decision in action 209.

As mentioned above, some of the embodiments may involve initial connection between the smart device 101 and the wireless communication device 121 via, e.g., NFC followed by continued connection via, e.g., Bluetooth or WiFi. In some of these embodiments, the AA procedure in action 203 may involve an initial NFC connection followed by a Bluetooth or WiFi continuation. In other embodiments, the AA procedure in action 203 may be performed using an NFC connection and the subsequent connection, e.g. during the enrollment procedure in action 207, may be performed via a Bluetooth or WiFi connection.

Actions 209 and 211

The decision action 209 is performed as a consequence of the outcome of the AA process in action 203. That is, if the outcome of the AA process in action 203 is that the user is not authorized and authenticated, a check is made of how many attempts have been made without success in authorizing and authenticating the user. If the number of attempts is above a predetermined threshold number, which the skilled person will be able to determine, then the method may simply be ended or, as illustrated by action 211, the smart device 101 may be disabled prior to ending the method. Disabling the smart device 101 may involve procedures that erase parts of the memory 104 as well as other appropriate actions known to the skilled person, the purpose of which is to prevent misuse of the smart device 101 by unauthorized users.

Returning now to FIG. 1, embodiments of a smart device 101 for controlling enrollment in a fingerprint sensing system will be described in some more detail. FIG. 1 illustrates the smart device 101 that comprises a fingerprint sensor 108, input/output circuitry 106, a processor 102 and a memory 104. The memory 104 contains instructions executable by the processor 102 whereby the smart device 101 is operative to:
establish a connection 111 with a wireless communication device 121, said wireless communication device 121 comprising a man-machine interface, MMI, 130
perform a user 123 authentication and authorization, AA, process, and
depending on an outcome of said AA process, perform a fingerprint enrollment process that comprises registering data representing a fingerprint of the user 123 in the smart device and that comprises communication with said wireless communication device 121 via said connection 111.

The instructions that are executable by the processor 102 may be software in the form of a computer program 141. The computer program 141 may be contained in or by a carrier 142, which may provide the computer program 141 to the memory 104 and processor 102. The carrier 142 may be in any suitable form including an electronic signal, an optical signal, a radio signal or a computer readable storage medium.

In some embodiments, the AA process comprises communication with the wireless communication device 121 via said connection 111.

In some embodiments, the smart device 101 is operative such that the AA process comprises receiving user input from said MMI 130 via said connection 111 from the wireless communication device 121.

In some embodiments, the smart device 101 is operative such that the AA process comprises receiving data representing AA process outcome via said connection 111 from the wireless communication device 121.

In some embodiments, the smart device 101 is operative such that said AA process comprises detecting a user triggered signal in the smart device.

In some embodiments, the smart device 101 is operative such that the fingerprint enrollment process comprises detecting fingerprint images in the fingerprint sensor 108 and transmitting guidance information to said MMI 130 via said connection 111 to the wireless communication device 121.

In some embodiments, the smart device 101 is operative such that the fingerprint enrollment process comprises receiving fingerprint images from the wireless communication device 121 and transmitting guidance information to said MMI 130 via said connection 111 to the wireless communication device 121.

In some embodiments, the smart device 101 is operative such that the fingerprint enrollment process comprises receiving said data representing a fingerprint via said connection 111 from the wireless communication device 121.

In some embodiments, the smart device 101 is operative such that the performing of the AA process is iterated and wherein the smart device is further operative to:
check whether or not said AA process is performed a specific number of times and if said specific number of times is above a first threshold number, then operative to end.

In some embodiments, the smart device 101 is operative such that the performing of the AA process is iterated and wherein the smart device is further operative to:
check whether or not said AA process is performed a specific number of times and if said specific number of times is above a second threshold number, then operative to disable the smart device 101 and operative to end.

In some embodiments, the smart device 101 is operative such that said connection with the wireless communication device is any of a NFC, Bluetooth®, RFID and WiFi connection.

1. A method of initially enrolling a user of a smart device comprising a fingerprint sensor, the method comprising:
establishing a connection with a wireless communication device, said wireless communication device comprising a man-machine interface, MMI;
performing a user authentication and authorization, AA, process including:
receiving, by said wireless communication device, user input via said MMI; and
authenticating said user input by at least one of said smart device and said wireless communication device; and
performing, when said AA process is successful, a fingerprint enrollment process that comprises registering, in the smart device, data representing a fingerprint of the user, said fingerprint enrollment process including communication between said smart device (101) and said wireless communication device via said connection.

2. The method of claim 1, wherein said AA process comprises communication with said wireless communication device via said connection.

3. The method of claim 2, wherein said AA process comprises receiving user input from said MMI via said connection from the wireless communication device.

4. The method of claim 2, wherein said user input is authenticated by said wireless communication device, and said AA process comprises receiving, by said smart device, data representing a result of said AA process via said connection from the wireless communication device.

5. The method of claim 1, wherein said fingerprint enrollment process comprises detecting fingerprint images in the fingerprint sensor and transmitting guidance information to said MMI via said connection to the wireless communication device.

6. The method of claim 1, wherein said fingerprint enrollment process comprises receiving fingerprint images from the wireless communication device and transmitting guidance information to said MMI via said connection to the wireless communication device.

7. The method of claim 1, wherein said fingerprint enrollment process comprises receiving said data representing a fingerprint via said connection from the wireless communication device.

8. The method of claim 1, wherein said performing of the AA process is iterated and wherein the method further comprises:
checking whether or not said AA process is performed a specific number of times and if said specific number of times is above a first threshold number, then ending the method.

9. The method of claim 1, wherein said performing of the AA process is iterated and wherein the method further comprises:
checking whether or not said AA process is performed a specific number of times and if said specific number of times is above a second threshold number, then disabling the smart device and ending the method.

10. The method of claim 1, wherein said connection with the wireless communication device comprises any of a near field communication, NFC, Bluetooth®, radio frequency identification, RFID, and WiFi connection.

11. A method of initially enrolling a user of a smart device comprising a fingerprint sensor, the method comprising:
establishing a connection between said smart device and a wireless communication device, said wireless communication device comprising a man-machine interface, MMI;
performing, by said smart device, a user authentication and authorization, AA, process; and
performing, when said AA process is successful, a fingerprint enrollment process including:
detecting fingerprint images by the fingerprint sensor in said smart device,
analyzing, by said smart device, said fingerprint images to produce an analysis result;
providing said analysis result to said wireless communication device via said connection;
providing, by said wireless communication device, enrollment guidance based on said analysis result to the user via said MMI; and
enrolling the user on said smart device by registering data representing a fingerprint of the user, based on the detected fingerprint images.

12. The method of claim 11, wherein said AA process comprises detecting a user triggered signal in the smart device.

13. A smart device comprising a fingerprint sensor, input/output circuitry a processor and a memory, said memory containing instructions executable by said processor whereby the smart device is operative to:
establish a connection with a wireless communication device, said wireless communication device comprising a man-machine interface, MMI,
perform a user authentication and authorization, AA, process, and
perform, when said AA process is successful, a fingerprint enrollment process including:
detecting fingerprint images by the fingerprint sensor;
analyzing said fingerprint images to produce an analysis result;
providing said analysis result to said wireless communication device via said connection, thereby enabling said wireless communication device to provide enrollment guidance based on said analysis result to the user via said MMI; and
enrolling the user on said smart device by registering data representing a fingerprint of the user, based on the detected fingerprint images.

14. The smart device of claim 13, said smart device being a household apparatus.

15. A computer program, comprising instructions which, when executed on at least one processor in a smart device, cause the smart device to carry out the method according to claim 1.

16. A carrier comprising the computer program of claim 15, wherein the carrier is one of an electronic signal, an optical signal, a radio signal and a computer readable storage medium.
